(19) United States
(12) Patent Application Publication
(10) Pub. No.: US 2024/0202664 A1
(43) Pub. Date: Jun. 20, 2024

(54) ENERGY EFFICIENT COLLABORATION FOR ENVIRONMENTAL SOCIAL AND GOVERNANCE (ESG) DATA CONSOLIDATION AND VALIDATION IN THE METAVERSE

(71) Applicant: ACCENTURE GLOBAL SOLUTIONS LIMITED, Dublin 4 (IE)

(72) Inventors: Janardan MISRA, Bangalore (IN); Sanjay PODDER, Thane (IN)

(73) Assignee: ACCENTURE GLOBAL SOLUTIONS LIMITED, Dublin 4 (IE)

(21) Appl. No.: 18/081,264

(22) Filed: Dec. 14, 2022

(51) Int. Cl. G06Q 10/101; G06N 3/006

(52) U.S. Cl. CPC G06Q 10/101; G06N 3/006

(57) ABSTRACT

In some examples, energy efficient collaboration for environmental social and governance (ESG) data consolidation and validation may include identifying, based on a global correlation graph, correlated ESG dimensions for each ESG data analyzer of a plurality of ESG data analyzers with respect to a set of ESG dimensions on which an ESG data analyzer of the plurality of ESG data analyzers collects data for at least one organization avatar entity (OAE) of a plurality of OAEs. In this regard, decentralized groups of collaborating ESG data analyzers may be generated based on a collaboration potential between the plurality of ESG data analyzers. For an ESG data analyzer that is collecting data and based on an associated updated data model, a potential anomalous ESG event may be identified at a specific ESG dimension. Further, operation of an OAE associated with the ESG data analyzer that is collecting data may be controlled.

### BACKGROUND

A metaverse may be described as a hypothetical immersive virtual world. The metaverse may utilize a variety of technologies such as virtual reality (VR), augmented reality (AR), artificial intelligence, machine learning, etc., to provide an immersive experience. The metaverse may be used to analyze a variety of real world concepts in a virtual world.

### BRIEF DESCRIPTION OF DRAWINGS

Features of the present disclosure are illustrated by way of example and not limited in the following figure(s), in which like numerals indicate like elements, in which:

FIG. 1 illustrates a layout of an energy efficient collaboration for ESG data consolidation and validation apparatus, in accordance with an example of the present disclosure;

FIG. 2 illustrates an example block diagram for energy efficient collaboration for ESG data consolidation and validation, in accordance with an example of the present disclosure;

FIG. 3 illustrates a flowchart of an example method for energy efficient collaboration for ESG data consolidation and validation, in accordance with an example of the present disclosure; and

FIG. 4 illustrates a further example block diagram for energy efficient collaboration for ESG data consolidation and validation, in accordance with another example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Energy efficient collaboration for environmental social and governance (ESG) data consolidation and validation apparatuses, methods for energy efficient collaboration for ESG data consolidation and validation, and non-transitory computer readable media having stored thereon machine readable instructions to provide energy efficient collaboration for ESG data consolidation and validation are disclosed herein. The apparatuses, methods, and non-transitory computer readable media disclosed herein provide an energy efficient technique for dynamic runtime collaboration among ESG data analyzers involving interaction among the ESG data analyzers to build ESG data models. In this regard, the ESG data analyzers may interact by forming decentralized collaboration groups. The ESG data models may be applied to identify potential data anomalies at various levels based on collective analysis of information across ESG data analyzers within these collaboration and operational proximities among organization avatar entities (OAEs) embodied in a metaverse.

A metaverse may represent a collective virtual shared space. In this regard, the term ESG as utilized herein may refer to the factors of environment, social, and governance that are used to measure sustainability. For the apparatuses, methods, and non-transitory computer readable media disclosed herein, the metaverse may include avatars of organization entities (e.g., “OAEs”) as models of their real-world behaviors, and a system-of-systems model of how these OAEs interact with each other, particularly, with respect to causal chains of events.

With respect to the apparatuses, methods, and non-transitory computer readable media disclosed herein, secure data communication may represent one of the foundational design characteristics in the metaverse. In this regard, ESG data related to OAEs may be acquired and analyzed without risking confidentiality and organization sensitivity. Acquisition and analysis of reliable ESG data is technically challenging, for example, due to the relatively large number of ESG dimensions, complexities of operating environments, and data privacy issues.

In order to address at least the aforementioned technical challenges, the apparatuses, methods, and non-transitory computer readable media disclosed herein provide for the implementation of ESG data analyzers that operate in the metaverse. The ESG data analyzers may collaboratively learn from decentralized ESG data models. Further, the ESG data analyzers may collectively analyze a continuum of data for identifying potential anomalies at various levels ranging from the level of ESG dimensions with respect to specific organization entities to groups of operationally connected organization entities. The ESG data analyzers may collaboratively learn to perform ESG data analytics in the metaverse for collectively aggregating semantically related ESG data. The ESG data analyzers may determine if underlying processes generating the ESG data are potentially outlying. Thus, the apparatuses, methods, and non-transitory computer readable media disclosed herein provide for the dynamic runtime collaboration among ESG data analyzers. The dynamic runtime collaboration may include a collective broadcast-based interaction among ESG data analyzers to learn ESG data models. The dynamic runtime collaboration may be utilized to identify potential anomalous behaviors of OAEs based on collective analysis of information received from other ESG data analyzers under context and associated similarities among OAEs in the metaverse.

According to examples disclosed herein, the apparatuses, methods, and non-transitory computer readable media disclosed herein may implement energy efficient collaboration for ESG data consolidation and validation as follows.

At the outset, a correlation graph generator as disclosed herein may identify correlations among ESG dimensions for and across OAEs in the metaverse to generate local and global correlation graphs of ESG dimensions. An ESG dimension analyzer as disclosed herein may identify correlated ESG dimensions for each ESG data analyzer to generate a tensor of organization entities, ESG data analyzers, and ESG dimensions. A collaboration analyzer as disclosed herein may determine a collaboration potential between ESG data analyzers operating in the metaverse. A collaboration potential analyzer as disclosed herein may identify groups of ESG data analyzers with high intra-group collaboration potentials. A data model generator as disclosed herein may collaboratively build decentralized ESG data models. An anomalous event analyzer as disclosed herein may identify a potential anomalous ESG event for specific ESG dimensions. The anomalous event analyzer may identify potential anomalous ESG events at an organization entity level. The anomalous event analyzer may also identify potential anomalous ESG events for a cluster of organization entities. Further, the anomalous event analyzer may identify potential global anomalous ESG events.

The apparatuses, methods, and non-transitory computer readable media disclosed herein may provide technical benefits such as energy savings. In this regard, the apparatuses, methods, and non-transitory computer readable media disclosed herein may provide for the reduction of computational resources, and thus energy required to determine which ESG data analyzers can cooperate most effectively to build ESG data models and identification of a potential anomalous ESG event. The apparatuses, methods, and non-transitory computer readable media disclosed herein may provide for energy savings, for example, with respect to the effect of clustering based upon a collaboration potential as compared to a random grouping (also referenced to herein as Factor-1). The apparatuses, methods, and non-transitory computer readable media disclosed herein may provide for energy savings, for example, based on the effect of elimination of false positives using multi-level filtering, while identifying data-anomalies (also referenced to herein as Factor-2). Yet further, the apparatuses, methods, and non-transitory computer readable media disclosed herein may provide for energy savings, for example, based on the effect of confidence estimates in identifying data-anomalies as compared to without such estimates (also referenced to herein as Factor-3).

For the apparatuses, methods, and non-transitory computer readable media disclosed herein, the elements of the apparatuses, methods, and non-transitory computer readable media disclosed herein may be any combination of hardware and programming to implement the functionalities of the respective elements. In some examples described herein, the combinations of hardware and programming may be implemented in a number of different ways. For example, the programming for the elements may be processor executable instructions stored on a non-transitory machine-readable storage medium and the hardware for the elements may include a processing resource to execute those instructions. In these examples, a computing device implementing such elements may include the machine-readable storage medium storing the instructions and the processing resource to execute the instructions, or the machine-readable storage medium may be separately stored and accessible by the computing device and the processing resource. In some examples, some elements may be implemented in circuitry.

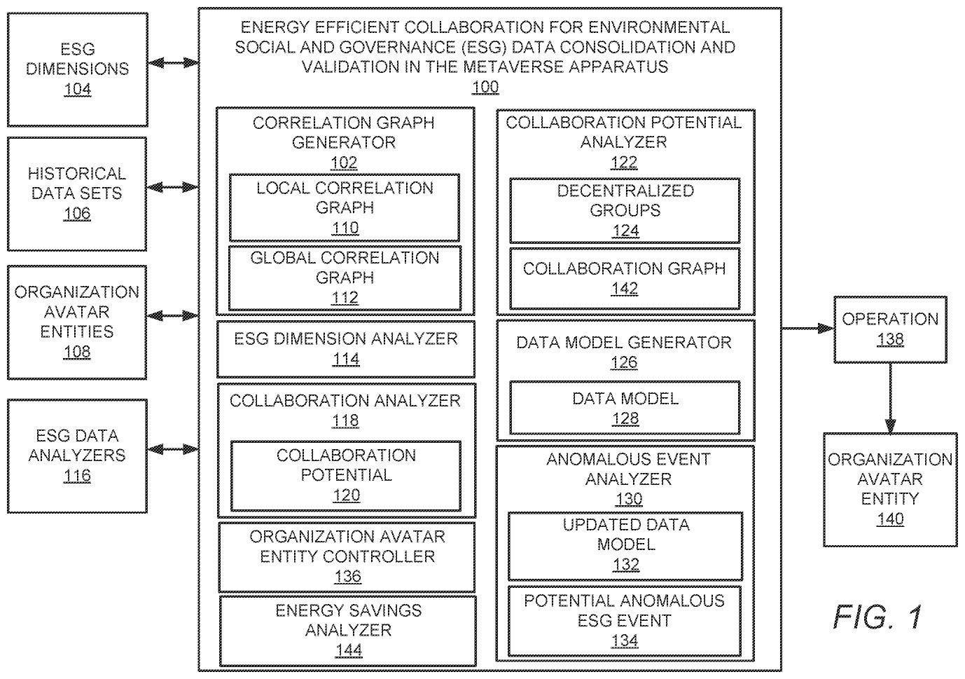

FIG. 1 illustrates a layout of an example energy efficient collaboration for ESG data consolidation and validation apparatus (hereinafter also referred to as “apparatus 100”).

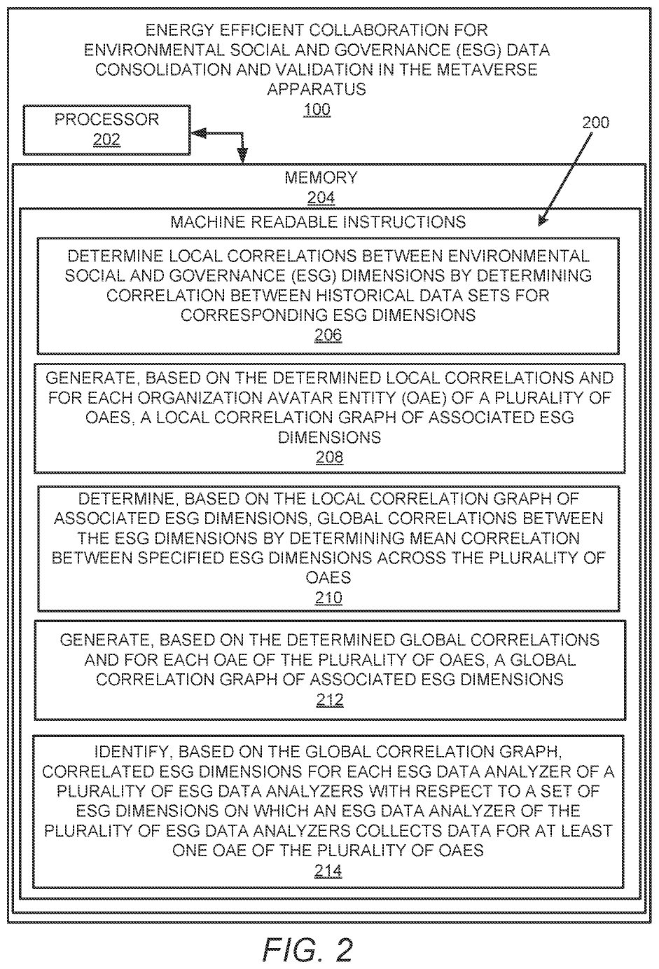

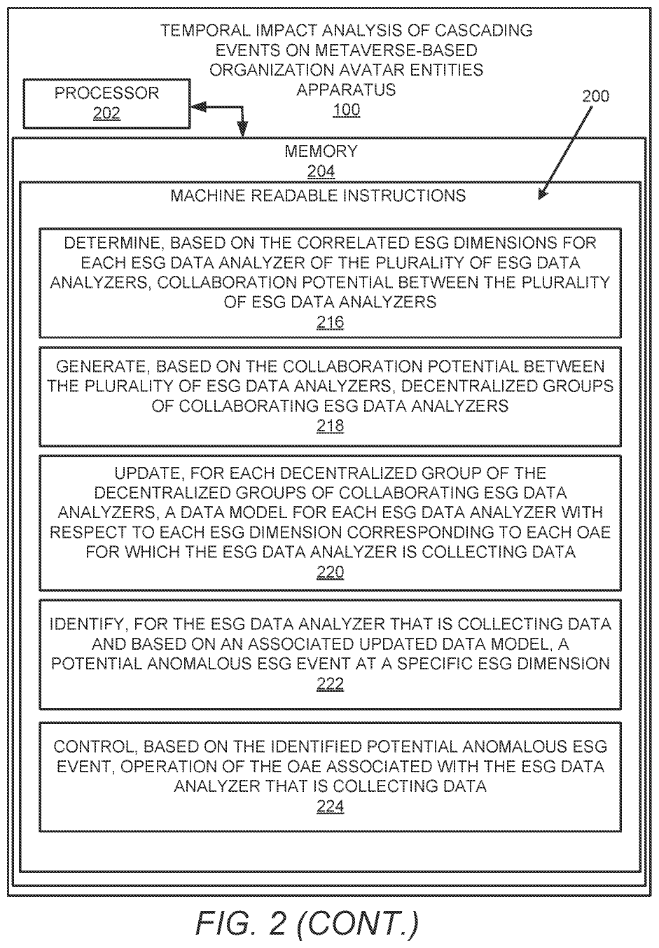

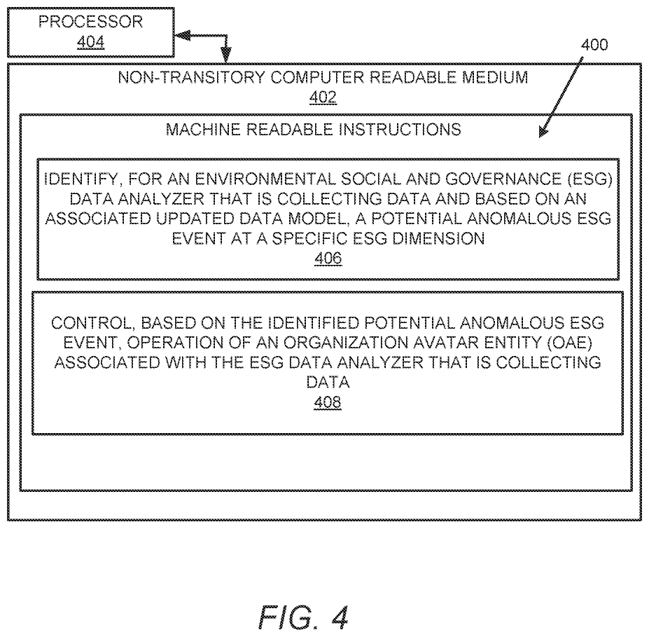

Referring to FIG. 1, the apparatus 100 may include a correlation graph generator 102 that is executed by at least one hardware processor (e.g., the hardware processor 202 of FIG. 2, and/or the hardware processor 404 of FIG. 4) to determine local correlations between ESG dimensions 104 by determining correlation between historical data sets 106 for corresponding ESG dimensions. The correlation graph generator 102 may generate, based on the determined local correlations and for each organization avatar entity (OAE) of a plurality of OAEs 108, a local correlation graph 110 of associated ESG dimensions. The correlation graph generator 102 may determine, based on the local correlation graph 110 of associated ESG dimensions, global correlations between the ESG dimensions 104 by determining mean correlation between specified ESG dimensions across the plurality of OAEs 108. Further, the correlation graph generator 102 may generate, based on the determined global correlations and for each OAE of the plurality of OAEs 108, a global correlation graph 112 of associated ESG dimensions.

An ESG dimension analyzer 114 that is executed by at least one hardware processor (e.g., the hardware processor 202 of FIG. 2, and/or the hardware processor 404 of FIG. 4) may identify, based on the global correlation graph 112, correlated ESG dimensions for each ESG data analyzer of a plurality of ESG data analyzers 116 with respect to a set of ESG dimensions on which an ESG data analyzer of the plurality of ESG data analyzers 116 collects data for at least one OAE of the plurality of OAEs 108.

A collaboration analyzer 118 that is executed by at least one hardware processor (e.g., the hardware processor 202 of FIG. 2, and/or the hardware processor 404 of FIG. 4) may determine, based on the correlated ESG dimensions for each ESG data analyzer of the plurality of ESG data analyzers 116, collaboration potential 120 between the plurality of ESG data analyzers 116.

A collaboration potential analyzer 122 that is executed by at least one hardware processor (e.g., the hardware processor 202 of FIG. 2, and/or the hardware processor 404 of FIG. 4) may generate, based on the collaboration potential 120 between the plurality of ESG data analyzers 116, decentralized groups 124 of collaborating ESG data analyzers.

A data model generator 126 that is executed by at least one hardware processor (e.g., the hardware processor 202 of FIG. 2, and/or the hardware processor 404 of FIG. 4) may update, for each decentralized group of the decentralized groups 124 of collaborating ESG data analyzers, a data model 128 for each ESG data analyzer with respect to each ESG dimension corresponding to each OAE for which the ESG data analyzer is collecting data.

An anomalous event analyzer 130 that is executed by at least one hardware processor (e.g., the hardware processor 202 of FIG. 2, and/or the hardware processor 404 of FIG. 4) may identify, for the ESG data analyzer that is collecting data and based on an associated updated data model 132, a potential anomalous ESG event 134 at a specific ESG dimension.

A OAE controller 136 that is executed by at least one hardware processor (e.g., the hardware processor 202 of FIG. 2, and/or the hardware processor 404 of FIG. 4) may control, based on the identified potential anomalous ESG event 134, operation 138 of the OAE 140 associated with the ESG data analyzer that is collecting data. For example, malfunctioning of a sensor measuring emissions related to greenhouse gases at a manufacturing unit of an OAE may represent an example of an anomalous ESG event as such a malfunctioning sensor would be sending incorrect measurement data. On detecting this data sent by the sensor as an outlier, an OAE may remove such data from records, stop processing this data for further analytics, and may send a signal to sensor operating agent devices to indicate potential malfunctioning of the sensor.

According to examples disclosed herein, the collaboration analyzer 118 may determine, based on the correlated ESG dimensions for each ESG data analyzer of the plurality of ESG data analyzers 116, the collaboration potential between the plurality of ESG data analyzers 116 by determining, for each pair of ESG data analyzers of the plurality of ESG data analyzers 116, a degree to which ESG data analyzers of the pair of ESG data analyzers collaborate with each other to enrich their data collection.

According to examples disclosed herein, the collaboration potential analyzer 122 may generate, based on the collaboration potential 120 between the plurality of ESG data analyzers 116, the decentralized groups 124 of collaborating ESG data analyzers by generating a collaboration graph 142 between the plurality of ESG data analyzers 116. For the collaboration graph 142, weights of edges may represent collaboration potentials between connected ESG data analyzers.

According to examples disclosed herein, the collaboration potential analyzer 122 may generate the collaboration graph 142 between the plurality of ESG data analyzers 116 by retaining, for the collaboration graph 142, edges that include a collaboration potential that is greater than a specified threshold.

According to examples disclosed herein, the anomalous event analyzer 130 may identify, for the ESG data analyzer that is collecting data and based on the associated updated data model 128, the potential anomalous ESG event 134 at the specific ESG dimension by rebuilding, for the ESG data analyzer that is collecting data, a local data model to generate the updated data model 128, and determining a difference between the updated data model 128 from the local data model.

According to examples disclosed herein, the anomalous event analyzer 130 may determine, for a specified number of ESG dimensions, whether a data anomaly is true for the OAE associated with the ESG data analyzer. Further, the anomalous event analyzer 130 may identify, based on a determination that the data anomaly is true for the OAE associated with the ESG data analyzer for the specified number of ESG dimensions, the potential anomalous ESG event 134.

According to examples disclosed herein, the anomalous event analyzer 130 may determine, for a specified number of OAEs in a cluster of OAEs, whether a data anomaly is true. Further, the anomalous event analyzer 130 may identify, based on a determination that the data anomaly is true for the specified number of OAEs in the cluster of OAEs, the potential anomalous ESG event 134 for the cluster of OAEs.

According to examples disclosed herein, the anomalous event analyzer 130 may determine, for a specified number of OAEs in a cluster of OAEs, whether a data anomaly is true for a specified ESG dimension. Further, the anomalous event analyzer 130 may identify, based on a determination that the data anomaly is true for the specified ESG dimension for the specified number of OAEs in the cluster of OAEs, the potential anomalous ESG event 134 at a global level for the specified ESG dimension.

Operation of the apparatus 100 is described in further detail.

With respect to the apparatus 100, OAEs may be defined as A=a₁, a₂, . . . , aₙ. Each OAE may represent a programmable model of organization with unique identity emulating abstraction of operations of organization entities in the metaverse. ESG dimensions may be defined as esgDim=d₁, d₂, . . . , dₘ. ESG dimensions may correspond to measurable characteristic of OAEs associated with sustainable goals. ESG data analyzers 116 may be defined as compAg=g₁, . . . , gₗ, and represent computational processes in the metaverse executing aggregation and analysis of data points for specific ESG dimensions for specific OAEs. An ESG data analyzer may aggregate data for multiple ESG dimensions for multiple OAEs.

Examples of ESG dimensions may include green house gases (GHG), total consumed energy, renewable energy, environmental impact, climate change vulnerability, etc. Renewable energy may include energy from renewable resources including sunlight, wind, rain, tides, waves, and geothermal heat. Environmental impact may include any change to the environment, whether adverse or beneficial, resulting from an organization's activities, products, or services. Further, climate change vulnerability may represent the degree to which a system is susceptible to and unable to cope with adverse effects of climate change including climate variability and extremes.

With respect to energy efficient collaboration for ESG data consolidation and validation, the apparatus 100 may perform steps [1]-[12] as described below. The steps [1]-[12] described below are specified to facilitate a description of operation of the apparatus 100, and not to limit the scope of operation of the apparatus 100 to the specified steps, which may be different than the order specified for the steps described below, or which may eliminate one or more of the steps described below.

Referring to FIG. 1, a first step (e.g., step [1]) that may be executed by the correlation graph generator 102 may include determining local correlations between ESG dimensions 104 by determining correlation between historical data sets 106 for corresponding ESG dimensions. For example, the correlation graph generator 102 may identify local correlations among ESG dimensions 104. For each OAE a∈A, for each pair (d₁, d₂)∈esgDim² such that d₁≠d₂, the correlation graph generator 102 may determine correlation between historical data sets s₁ and s₂ for d₁ and d₂ as follows:

$${corr}_{a} ( {d}_{1} , {d}_{2} ) = \frac{\sum ( {s}_{1} [ i ] - {μ}_{1} ) ( {s}_{2} [ i ] - {μ}_{2} )}{\sqrt{\sum {( {s}_{1} [ i ] - {μ}_{1} )}^{2} \sum {( {s}_{2} [ i ] - {μ}_{2} )}^{2}}} \qquad Equation ( 1 )$$

Historical data sets s₁ and s₂ may include data associated with ESG dimensions d₁ and d₂. These data, for example, may represent measurements of events related to these ESG dimensions. Further, μ₁ and μ₂ are the averages of the data in s₁ and s₂.

A second step (e.g., step [2]) that may be executed by the correlation graph generator 102 may include generating, based on the determined local correlations and for each OAE of a plurality of OAEs 108, a local correlation graph 110 of associated ESG dimensions. For example, the correlation graph generator 102 may generate local correlation graphs of ESG dimensions. For each OAE, a∈A, the correlation graph generator 102 may generate a weighted undirected graph G=(Vₐ, Eₐ, Wₐ) of ESG dimensions such that for each dimension d∈esgDim there is a node v_{d} in Vₐ, and for each edge (v_{d}_{₁}, v_{d}_{₂})∈Eₐ, weight w is the correlation between d₁ and d₂ as follows:

$$w ( {v}_{{d}_{1}} , {v}_{{d}_{2}} ) = {corr}_{a} ( {d}_{1} , {d}_{2} ) \qquad Equation ( 2 )$$

In this regard, Vₐ may represent the set of nodes in graph Gₐ, Eₐ may represent the set of edges between a pair of nodes in the graph Gₐ, and wₐ may represent a function that associates weights with these edges.

A third step (e.g., step [3]) that may be executed by the correlation graph generator 102 may include determining, based on the local correlation graph 110 of associated ESG dimensions, global correlations between the ESG dimensions 104 by determining mean correlation between specified ESG dimensions across the plurality of OAEs 108. For example, the correlation graph generator 102 may identify global correlations among ESG dimensions. For each pair (d₁, d₂)∈esgDim² such that d₁≠d₂, the correlation graph generator 102 may determine mean correlation between d₁ and d₂ across all OAEs as follows:

$${mean}_{corr} ( {d}_{1} , {d}_{2} ) = \frac{1}{\vert A \vert} {\sum }_{a ∈ A} {corr}_{a} ( {d}_{1} , {d}_{2} ) \qquad Equation ( 3 )$$

A fourth step (e.g., step [4]) that may be executed by the correlation graph generator 102 may include generating, based on the determined global correlations and for each OAE of the plurality of OAEs 108, a global correlation graph 112 of associated ESG dimensions. For example, the correlation graph generator 102 may generate a global correlation graph 112 of ESG dimensions. The correlation graph generator 102 may generate a weighted undirected graph G=(V, E, w) of ESG dimensions such that for each dimension d∈esgDim there is a node v_{d} in V, and for each edge (v_{d}_{₁}, v_{d}_{₂})∈E, its weight w is the average correlation between d₁ and d₂ across OAEs as follows:

$$w ( {v}_{{d}_{1}} , {v}_{{d}_{2}} ) = {mean}_{corr} ( {d}_{1} , {d}_{2} ) \qquad Equation ( 4 )$$

In this regard, V may represent the set of nodes in graph G, E may represent the set of edges between a pair of nodes in the graph G, and w may represent a function which associates weights with these edges.

A fifth step (e.g., step [5]) that may be executed by the ESG dimension analyzer 114 may include identifying, based on the global correlation graph 112, correlated ESG dimensions for each ESG data analyzer of a plurality of ESG data analyzers 116 with respect to a set of ESG dimensions on which an ESG data analyzer of the plurality of ESG data analyzers 116 collects data for at least one OAE of the plurality of OAEs 108. For example, the ESG dimension analyzer 114 may identify correlated ESG dimensions for each ESG data analyzer. For each ESG data analyzer g∈CompAg, dim(g) may represent the set of ESG dimensions on which g collects data for one or more OAEs as follows:

$$dim ( g ) = \{ \begin{matrix}d ∈ esgDim \vert agent g collects data on dimension d \\ for subset of OAEs {A}_{g} ⊆ A\end{matrix} \qquad Equation ( 5 )$$

Further, for each pair of dimensions d₁, d₂∈dim(g) such that d₁≠d₂, the ESG dimension analyzer 114 may estimate correlations between d₁ and d₂ as a mean correlation across OAEs as follows:

$${A}_{g} {corr}_{g} ( {d}_{1} , {d}_{2} ) = {mean}_{a ∈ {A}_{g}} {corr}_{a} ( {d}_{1} , {d}_{2} ) \qquad Equation ( 6 )$$

Next, with respect to collective learning of building ESG data models, a sixth step (e.g., step [6]) that may be executed by the collaboration analyzer 118 may include determining, based on the correlated ESG dimensions for each ESG data analyzer of the plurality of ESG data analyzers 116, collaboration potential 120 between the plurality of ESG data analyzers 116. For example, the collaboration analyzer 118 may estimate collaboration potential between ESG data analyzers 116. The collaboration potential colPot(•)∈[0 . . . 1] between two ESG data analyzers g₁ and g₂ may represent a measure of how well can g₁ and g₂ collaborate with each other to enrich their data collection and validation as follows:

$$colPot ( {g}_{1} , {g}_{2} ) = ρ \times θ \qquad Equation ( 7 )$$

$$ρ ( {g}_{1} , {g}_{2} ) = \frac{1}{\vert bae ( {g}_{1} ) \vert} {\sum }_{a ∈ bae ( {g}_{1} )} {max}_{b ∈ bae ( {g}_{2} )} opProx ( a , b ) \qquad Equation ( 8 )$$

For Equation (8), bae(g) may represent a set of organization entities for which ESG data analyzer g is collecting data. Further, opProx(a, b) may represent a perational proximity between organization entities a and b.

$$θ = \frac{\vert dim ( {g}_{1} ) ⋂ dim ( {g}_{2} ) \vert + {Λ}_{g 1} + {Λ}_{g 2}}{\vert dim ( {g}_{1} ) ⋃ dim ( {g}_{2} ) ) \vert} \qquad Equation ( 9 )$$

$${Λ}_{g 1} = {\sum }_{{d}_{i} ∈ dim ( {g}_{1} ) \backslash dim ( {g}_{2} )} {max}_{{d}_{j} ∈ dim ( {g}_{2} )} {corr}_{g} ( {d}_{i} , {d}_{j} ) \qquad Equation ( 10 )$$

$${Λ}_{g 2} = {\sum }_{{d}_{j} ∈ dim ( {g}_{2} ) \backslash dim ( {g}_{1} )} {max}_{{d}_{i} ∈ dim ( {g}_{1} )} {corr}_{g} ( {d}_{j} , {d}_{i} ) \qquad Equation ( 11 )$$

Collaboration potential between two ESG data analyzers may be determined by operational proximities between OAEs for which these ESG data analyzers are collecting data, and statistical correlational proximities among ESG dimensions on which they are collecting data.

A seventh step (e.g., step [7]) that may be executed by the collaboration potential analyzer 122 may include generating, based on the collaboration potential 120 between the plurality of ESG data analyzers 116, decentralized groups 124 of collaborating ESG data analyzers. For example, the collaboration potential analyzer 122 may generate decentralized groups of collaborating ESG data analyzers 116. The collaboration potential analyzer 122 may generate a collaboration graph 142 between ESG data analyzers 116 such that weights of edges are collaboration potentials between connected ESG data analyzers. The collaboration potential analyzer 122 may retain those edges that have collaboration potentials ≥δ∈(0 . . . 1] (default=0.85, e.g., strong collaboration potential). The collaboration potential analyzer 122 may apply graph clustering techniques, such as maximal connected components, to create groups of ESG data analyzers with high intra-group collaboration potentials.

With respect to collaborative learning, for an eighth step (e.g., step [8]) that may be executed by the data model generator 126 may include updating, for each decentralized group of the decentralized groups 124 of collaborating ESG data analyzers, a data model 128 for each ESG data analyzer with respect to each ESG dimension corresponding to each OAE for which the ESG data analyzer is collecting data. For example, within each cluster, the data model generator 126 may implement local learning. In this regard, each ESG data analyzer may update its local data model (e.g., statistical distribution of data points) along each dimension corresponding to each OAE for which the ESG data analyzer is sensing data. Within each cluster, with respect to collective learning, along each dimension, for subgroups of ESG data analyzers that are collecting data along that dimension, the data model generator 126 may combine their data for learning the collective data model. In order to combine data corresponding to different OAEs, at each time, the data model generator 126 may analyze a mean value across different OAEs.

Next, the anomalous event analyzer 130 may perform anomaly detection, at the level of the specific ESG dimension of an OAE, specific OAE, OAE cluster, and globally.

A ninth step (e.g., step [9]) that may be executed by the anomalous event analyzer 130 may include identifying, for the ESG data analyzer that is collecting data and based on an associated updated data model 132, a potential anomalous ESG event 134 at a specific ESG dimension. As new data-points (X) are received by an ESG data analyzer on a specific ESG dimension, the ESG data analyzer may rebuild its local data model and then estimate the difference between the new data model from an existing data model. In this regard, the distance between the existing data model (M_{old}) and the updated data model (M_{new}) may be determined as follows:

$$diff ( {M}_{old} , {M}_{new} ) = \frac{1}{2} ( {\sum }_{x ∈ X} {M}_{old} ( x ) log ( \frac{2 * {M}_{old} ( x )}{{M}_{old} ( x ) + {M}_{new} ( x )} ) + {\sum }_{x ∈ X} {M}_{new} ( x ) log ( \frac{2 * {M}_{new} ( x )}{{M}_{old} ( x ) + {M}_{new} ( x )} ) ) \qquad Equation ( 12 )$$

$$Next , if ( {C}_{d} ( d , a ) AND {C}_{c} ( d , a ) AND {C}_{g} ( d , a ) )$$

$$then$$

$$DataAnomaly ( d , a , t ) ← YES with conf ( d , a , t ) = {π}_{d} * {π}_{c} * {π}_{g} \qquad Equation ( 13 )$$

For Equation (13), C_{d}(d, a) and C_{c}(d, a) and C_{g}(d, a) may represent a Boolean conjunction of three separate conditions. A first condition C_{d}(d, a) may determine whether an old data model M_{old} is sufficiently different from new data model M_{new}. A second condition C_{c}(d, a) may determine whether there exists another ESG dimension d′ associated with OAE a, which was highly correlated with ESG dimension d, however, such correlation between d and d′ when estimated using new data may be different from when estimated using prior data. A third condition C_{g}(d, a) may determine whether the above conditions are false for most other OAEs in the cluster where OAE a belongs. In terms of these, C_{d}(d, a) and C_{c}(d, a) and C_{g}(d, a) may determine whether all these conditions hold together with respect to a new data. For Equation (13), C_{g}(d, a) may be determined as follows: diff(M_{old}, M_{new})≥η_{d} (default η_{d}=0.25). For Equation (13), with respect to C_{c}(d, a), there exists an ESG dimension d′ that has high correlation with d with respect to OAE a, e.g., corrₐ(d, d′)≥∈ (default ∈=0.85) such that

$$\vert {{corr}_{a} ( d , {d}^{′} )}^{updated} - {corr}_{a} ( d , {d}^{′} ) \vert \geq {η}_{c} \qquad Equation ( 14 )$$

(default η_{c}=0.25), where corrₐ(d, d′)^{updated} is correlation between d and d′ using updated data-sets.
For Equation (13), C_{g}(d, a) may be determined as follows:

$${c}_{d} ( d , {a}^{′} ) AND {C}_{c} ( d , {a}^{′} ) = False for {η}_{g} ∈ 0 .. 1 fraction of other OAEs in cluster \qquad Equation ( 15 )$$

$$For Equation ( 13 ) , {π}_{d} * {π}_{c} * {π}_{g} may be determined as follows :$$

$${π}_{d} = diff ( {M}_{old} , {M}_{new} ) \qquad Equation ( 16 )$$

$${π}_{c} = \vert {{corr}_{a} ( d , {d}^{′} )}^{updated} - {corr}_{a} ( d , {d}^{′} ) \vert \qquad Equation ( 17 )$$

$${π}_{g} = {η}_{g} \qquad Equation ( 18 )$$

For Equation (13), DataAnomaly(d, a, t) may indicate whether there is a potential data anomaly in the current batch of data-points corresponding to ESG dimension d with respect to OAE a. Further, conf(d, a, t) may represent the measure of confidence on the estimation of the DataAnomaly(d, a, t).

ESG data analyzers 116 associated with OAE a may update their local data models on ESG dimensions d∈esgDim. After updating the data model for d, these ESG data analyzers 116 may estimate its difference from existing data models. If the difference between the data models is more than threshold η_{d}, the anomalous event analyzer 130 may determine if the correlation of d with at least one of the correlated dimensions has changed above a threshold η_{c}. If yes, the anomalous event analyzer 130 may determine if similar changes have occurred only for a small η_{g} fraction of other OAEs in the cluster C, where a belongs. If yes, the anomalous event analyzer 130 may flag a potential data anomaly on ESG dimension d with respect to the data-points collected at the last timepoint t from where deviations are estimated for OAE a.

A tenth step (e.g., step [10]) that may be executed by the anomalous event analyzer 130 may include identification of potential anomalous ESG events for an organization entity.

$$Θ ( a , t ) = \{ d ∈ esgDim \vert new data points exist on d with respect to a at time point t \} \qquad Equation ( 19 )$$

$${φ}_{a} ( t ) = \{ d ∈ Θ ( a , t ) \vert DataAnomaly ( d , a , t ) = YES \} \qquad Equation ( 20 )$$

$$if ( {π}_{a} \geq {η}_{a} ) then$$

$$DataAnomaly ( a , t ) ← YES with$$

$$conf ( a , t ) = {π}_{a} * {\sum }_{d ∈ {φ}_{a} ( t )} conf ( d , a , t )$$

$$where$$

$${π}_{a} = {φ}_{a} ( t ) / Θ ( a , t ) \qquad Equation ( 21 )$$

For Equation (14), esgDim may represent the set of all ESG dimensions. If for a sufficient number of ESG dimensions ηₐ (default ηₐ=0.3), the data anomaly is true at time-point t with respect to OAE a, this condition may be used to indicate a data-anomaly at the OAE level.

An eleventh step (e.g., step [11]) that may be executed by the anomalous event analyzer 130 may include identification of potential anomalous ESG events for a group (e.g., cluster) of organization entities. For a group of collaborating ESG data analyzers C:

$${φ}_{C} ( t ) = \{ a ∈ C \vert DataAnomaly ( a , t ) = YES \} \qquad Equation ( 22 )$$

$$if ( {π}_{C} \geq {η}_{C} ) then$$

$$DataAnomaly ( C , t ) ← Yes with$$

$$conf ( C , t ) = {π}_{C} * {\sum }_{a ∈ {φ}_{C} ( t )} Conf ( a , t )$$

$$where$$

$${π}_{a} = {φ}_{C} ( t ) / \vert C \vert$$

If for a sufficient number of OAEs in the cluster C. e.g., η_{c} (default η_{c}=0.3), the data anomaly is true at time-point t, this condition may be used to indicate a data-anomaly at the OAE cluster level.

A twelfth step (e.g., step [12]) that may be executed by the anomalous event analyzer 130 may include identification of potential global anomalous ESG events. For each d∈esgDim:

$${φ}_{A} ( d , t ) = \{ a ∈ A \vert DataAnomaly ( d , a , t ) = YES \} \qquad Equation ( 23 )$$

$$if ( \frac{{φ}_{A} ( t )}{\vert A \vert} \geq {η}_{A} ) then$$

$$DataAnomaly ( d , A , t ) ← YES with$$

$$conf ( A , t ) = {π}_{A} * {\sum }_{a ∈ {φ}_{A} ( t )} conf ( d , a , t )$$

If for a sufficient number of (e.g., η_{A}, default=0.3) OAEs across clusters, a data anomaly is true at time-point t for ESG dimension d, this condition may be used to indicate a data-anomaly at a global level for ESG dimension d.

As disclosed herein, the apparatuses, methods, and non-transitory computer readable media disclosed herein may provide technical benefits such as energy savings. In this regard, the apparatuses, methods, and non-transitory computer readable media disclosed herein may provide for the reduction of computational resources, and thus energy required to determine which ESG data analyzers can cooperate most effectively to build ESG data models and identification of a potential anomalous ESG event. The apparatuses, methods, and non-transitory computer readable media disclosed herein may provide for energy savings, for example, based on the effect of clustering based upon collaboration potential as compared to random grouping (e.g., Factor-1 as disclosed herein). The apparatuses, methods, and non-transitory computer readable media disclosed herein may provide for energy savings, for example, based on the effect of elimination of false positives using multi-level filtering while identifying data-anomalies (e.g., Factor-2 as disclosed herein). Further, the apparatuses, methods, and non-transitory computer readable media disclosed herein may provide for energy savings, for example, based on the effect of confidence estimates in identifying data-anomalies as compared to without such estimates (e.g., Factor-3 as disclosed herein).

With respect to the aforementioned Factor-1 for energy savings due to collaboration potential based clustering, energy savings as compared to random grouping of ESG data analyzers may be represented as follows:

$${clustering}_{factors} = {( \frac{1}{\vert comp Ag \vert} {\sum }_{g ∈ comp Ag} s ( g ) )}^{- 1} \qquad Equation ( 24 )$$

For Equation (24), s(g), a(g), and b(g) may be determined as follows:

$$s ( g ) = \{ \begin{matrix}1 - \frac{a ( g )}{b ( g )} & if a ( g ) < b ( g ) \\ \frac{b ( g )}{a ( g )} - 1 & otherwise\end{matrix}$$

a(g)=average proximity of ESG data analyzer g with all other ESG data analyzers in its cluster
b(g)=minimum of the average of proximity of ESG data analyzer g with ESG data analyzers in other clusters
   Proximity between data analyzers may be determined using a similarity metric selected by the operating environment (e.g., Cosine similarity in terms of measured characteristics of the data analyzers) For example:

$$\begin{matrix}\cdot compAg = \{ {g}_{1} , {g}_{2} , {g}_{3} \} \\ •Clustering : \{ {g}_{1} , {g}_{3} \} , \{ {g}_{2} \} \\ \cdot a ( {g}_{1} ) = a ( {g}_{3} ) = 5 , a ( {g}_{2} ) = 0 \\ \cdot b ( {g}_{1} ) = a ( {g}_{3} ) = 5 , a ( {g}_{2} ) = 0 \\ \cdot s ( {g}_{1} ) = 1 - \frac{5}{7} = 0.286 , ( {g}_{3} ) = 1 - \frac{5}{8} = 0.375 , s ( {g}_{2} ) = 1 - \frac{0}{7.5} = 1 \\ {•clustering}_{factor} = {( \frac{1}{3} {\sum }_{g ∈ [ {g}_{1} , {g}_{2} , {g}_{3} ]} s ( g ) )}^{- 1} = {( \frac{1}{3} ( 0.286 + 0.375 + 1 ) )}^{- 1} = 1.81\end{matrix}$$

With respect to the aforementioned Factor-2 for energy savings due to multi-level of filtering to eliminate false positive, energy savings as compared to a scenario where such false positive are not detected may be represented as follows:

$$savings ( filtering ) = {α}_{+ ve} * {f}_{+} \qquad Equation ( 25 )$$

For Equation (25), α₊ᵥₑ may be determined as follows:

$${α}_{+ ve} = \frac{Number of false positive data ‐ points detected by multi ‐ level filtering}{Total number of processed data ‐ points}$$

$${f}_{+} = number of elementary computations required for processing data ‐ points$$

For example:

$$\begin{matrix}•Number of false positive data ‐ points detected by multi ‐ level filtering = 37 \\ •Total number of processed data ‐ points = 200 \\ \cdot {f}_{+} = {10}^{4} flops \\ •savings ( filtering ) = \frac{37}{200} * {10}^{4} = 1850 flops\end{matrix}$$

With respect to the aforementioned Factor-3 for energy savings due to confidence estimation con( ), the effect of confidence estimate of detecting data-anomaly as compared to without such estimate may be determined as follows. If there is no confidence estimate of the anomaly detection, a next level of ESG data-analysis process may execute computations to perform data-validation. Such a computation may involve steps similar to those disclosed herein for data model aberration in step [11]. Therefore, computational cost saving due to estimating confidence of anomaly assuming n data-points in set X may be determined as follows:

$$savings ( conf ) = {cost}_{M ( )} + {cost}_{diff} = n * ( {f}_{M} + {f}_{d} ) \qquad Equation ( 26 )$$

For Equation (26), cost_{M( )} and cost_{diff} may be determined as follows:

$$\begin{matrix}{cost}_{M ( )} = Computational cost of estimating data ‐ models {M}_{old} and {M}_{new} \\ {cost}_{M ( )} \approx n * {f}_{M} flops \\ {f}_{M} = number of elementary computations required for computing data models {M}_{old} and {M}_{new} \\ {cost}_{diff} = Computational cost of calculating diff ( {M}_{old} , {M}_{new} ) \\ {cost}_{diff} \approx n * {f}_{d} \\ {f}_{d} = number of elementary computations required for computing diff ( {M}_{old} , {M}_{new} )\end{matrix}$$

For example, suppose there are 200 data-points in set X and number of elementary computations required for computing data models M_{old} and M_{new} are 3*10⁴ flops and for computing diff(M_{old}, M_{new}) are 2*10⁴ flops, in this case, savings(conf)=200*(3*10⁴+2*10³)=64*10⁵ flops.

Energy savings may be determined by the energy savings analyzer 144 as follows:

$$energySav = {e}_{unit} * {totalComp}_{savings} \qquad Equation ( 27 )$$

For Equation (27), totalComp_{savings} and eᵤₙᵢₜ may be determined as follows:

$${totalComp}_{savings} = {clustering}_{factor} * ( savings ( filtering ) + savings ( conf ) )$$

$${e}_{unit} = energy consumed by unit computation i . e . , flop$$

For example, Equation (27) may be applied as follows:

$$\begin{matrix}\cdot {e}_{unit} = 2 kW h / flop \\ \cdot {totalComp}_{savings} = 1.83 * ( 1850 + 64 * {10}^{5} ) = 11715386 flops \\ \cdot energySav = 2 kW h / flop * 11715386 flop = 23430771 kW h\end{matrix}$$

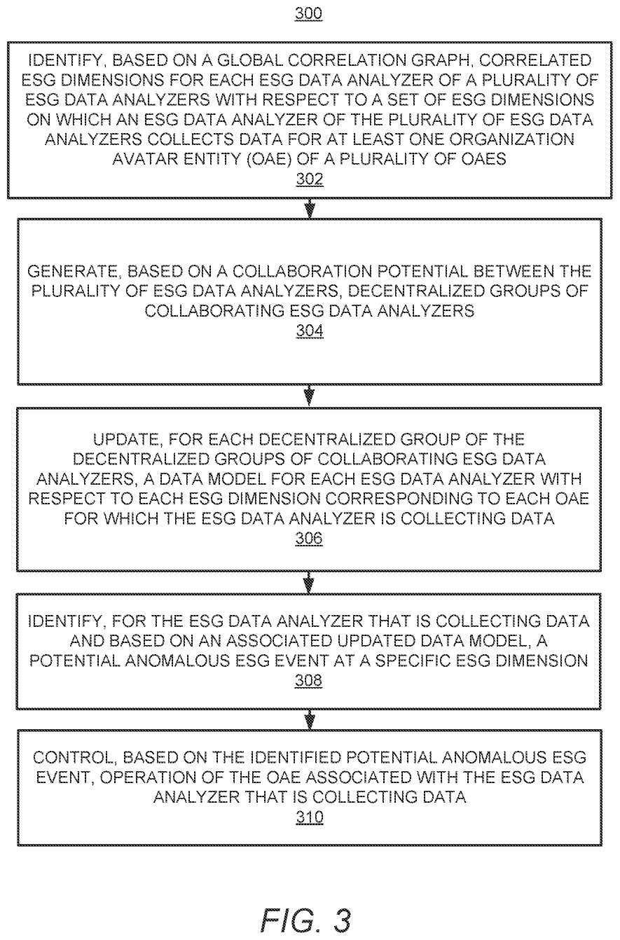

FIGS. 2-4 respectively illustrate an example block diagram 200, a flowchart of an example method 300, and a further example block diagram 400 for energy efficient collaboration for ESG data consolidation and validation, according to examples. The block diagram 200, the method 300, and the block diagram 400 may be implemented on the apparatus 100 described above with reference to FIG. 1 by way of example and not of limitation. The block diagram 200, the method 300, and the block diagram 400 may be practiced in other apparatus. In addition to showing the block diagram 200, FIG. 2 shows hardware of the apparatus 100 that may execute the instructions of the block diagram 200. The hardware may include a processor 202, and a memory 204 storing machine readable instructions that when executed by the processor cause the processor to perform the instructions of the block diagram 200. The memory 204 may represent a non-transitory computer readable medium. FIG. 3 may represent an example method for energy efficient collaboration for ESG data consolidation and validation, and the steps of the method. FIG. 4 may represent a non-transitory computer readable medium 402 having stored thereon machine readable instructions to provide energy efficient collaboration for ESG data consolidation and validation according to an example. The machine readable instructions, when executed, cause a processor 404 to perform the instructions of the block diagram 400 also shown in FIG. 4.

The processor 202 of FIG. 2 and/or the processor 404 of FIG. 4 may include a single or multiple processors or other hardware processing circuit, to execute the methods, functions and other processes described herein. These methods, functions and other processes may be embodied as machine readable instructions stored on a computer readable medium, which may be non-transitory (e.g., the non-transitory computer readable medium 402 of FIG. 4), such as hardware storage devices (e.g., RAM (random access memory), ROM (read only memory), EPROM (erasable, programmable ROM), EEPROM (electrically erasable, programmable ROM), hard drives, and flash memory). The memory 204 may include a RAM, where the machine readable instructions and data for a processor may reside during runtime.

Referring to FIGS. 1-2, and particularly to the block diagram 200 shown in FIG. 2, the memory 204 may include instructions 206 to determine local correlations between ESG dimensions 104 by determining correlation between historical data sets 106 for corresponding ESG dimensions.

The processor 202 may fetch, decode, and execute the instructions 208 to generate, based on the determined local correlations and for each organization avatar entity (OAE) of a plurality of OAEs 108, a local correlation graph 110 of associated ESG dimensions.

The processor 202 may fetch, decode, and execute the instructions 210 to determine, based on the local correlation graph 110 of associated ESG dimensions, global correlations between the ESG dimensions 104 by determining mean correlation between specified ESG dimensions across the plurality of OAEs 108.

The processor 202 may fetch, decode, and execute the instructions 212 to generate, based on the determined global correlations and for each OAE of the plurality of OAEs 108, a global correlation graph 112 of associated ESG dimensions.

The processor 202 may fetch, decode, and execute the instructions 214 to identify, based on the global correlation graph 112, correlated ESG dimensions for each ESG data analyzer of a plurality of ESG data analyzers 116 with respect to a set of ESG dimensions on which an ESG data analyzer of the plurality of ESG data analyzers 116 collects data for at least one OAE of the plurality of OAEs 108.

The processor 202 may fetch, decode, and execute the instructions 216 to determine, based on the correlated ESG dimensions for each ESG data analyzer of the plurality of ESG data analyzers 116, collaboration potential 120 between the plurality of ESG data analyzers 116.

The processor 202 may fetch, decode, and execute the instructions 218 to generate, based on the collaboration potential 120 between the plurality of ESG data analyzers 116, decentralized groups 124 of collaborating ESG data analyzers.

The processor 202 may fetch, decode, and execute the instructions 220 to update, for each decentralized group of the decentralized groups 124 of collaborating ESG data analyzers, a data model 128 for each ESG data analyzer with respect to each ESG dimension corresponding to each OAE for which the ESG data analyzer is collecting data.

The processor 202 may fetch, decode, and execute the instructions 222 to identify, for the ESG data analyzer that is collecting data and based on an associated updated data model 132, a potential anomalous ESG event 134 at a specific ESG dimension.

The processor 202 may fetch, decode, and execute the instructions 224 to control, based on the identified potential anomalous ESG event 134, operation 138 of the OAE 140 associated with the ESG data analyzer that is collecting data.

Referring to FIGS. 1 and 3, and particularly FIG. 3, for the method 300, at block 302, the method may include identifying, based on a global correlation graph, correlated ESG dimensions for each ESG data analyzer of a plurality of ESG data analyzers with respect to a set of ESG dimensions on which an ESG data analyzer of the plurality of ESG data analyzers collects data for at least one OAE of a plurality of OAEs.

At block 304, the method may include generating, based on a collaboration potential between the plurality of ESG data analyzers, decentralized groups of collaborating ESG data analyzers.

At block 306, the method may include updating, for each decentralized group of the decentralized groups of collaborating ESG data analyzers, a data model for each ESG data analyzer with respect to each ESG dimension corresponding to each OAE for which the ESG data analyzer is collecting data.

At block 308, the method may include identifying, for the ESG data analyzer that is collecting data and based on an associated updated data model, a potential anomalous ESG event at a specific ESG dimension.

At block 310, the method may include controlling, by the at least one hardware processor, based on the identified potential anomalous ESG event, operation of the OAE associated with the ESG data analyzer that is collecting data.

Referring to FIGS. 1 and 4, and particularly FIG. 4, for the block diagram 400, the non-transitory computer readable medium 402 may include instructions 406 to identify, for an ESG data analyzer that is collecting data and based on an associated updated data model, a potential anomalous ESG event at a specific ESG dimension.

The processor 404 may fetch, decode, and execute the instructions 408 to control, based on the identified potential anomalous ESG event, operation of an OAE associated with the ESG data analyzer that is collecting data.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. An energy efficient collaboration for environmental social and governance (ESG) data consolidation and validation apparatus comprising:
at least one hardware processor;
a correlation graph generator, executed by the at least one hardware processor, to:
determine local correlations between ESG dimensions by determining correlation between historical data sets for corresponding ESG dimensions;
generate, based on the determined local correlations and for each organization avatar entity (OAE) of a plurality of OAEs, a local correlation graph of associated ESG dimensions;
determine, based on the local correlation graph of associated ESG dimensions, global correlations between the ESG dimensions by determining mean correlation between specified ESG dimensions across the plurality of OAEs; and
generate, based on the determined global correlations and for each OAE of the plurality of OAEs, a global correlation graph of associated ESG dimensions;
an ESG dimension analyzer, executed by the at least one hardware processor, to:
identify, based on the global correlation graph, correlated ESG dimensions for each ESG data analyzer of a plurality of ESG data analyzers with respect to a set of ESG dimensions on which an ESG data analyzer of the plurality of ESG data analyzers collects data for at least one OAE of the plurality of OAEs;
a collaboration analyzer, executed by the at least one hardware processor, to:
determine, based on the correlated ESG dimensions for each ESG data analyzer of the plurality of ESG data analyzers, collaboration potential between the plurality of ESG data analyzers;
a collaboration potential analyzer, executed by the at least one hardware processor, to:
generate, based on the collaboration potential between the plurality of ESG data analyzers, decentralized groups of collaborating ESG data analyzers;
a data model generator, executed by the at least one hardware processor, to:
update, for each decentralized group of the decentralized groups of collaborating ESG data analyzers, a data model for each ESG data analyzer with respect to each ESG dimension corresponding to each OAE for which the ESG data analyzer is collecting data;
an anomalous event analyzer, executed by the at least one hardware processor, to:
identify, for the ESG data analyzer that is collecting data and based on an associated updated data model, a potential anomalous ESG event at a specific ESG dimension; and
a OAE controller, executed by the at least one hardware processor, to:
control, based on the identified potential anomalous ESG event, operation of the OAE associated with the ESG data analyzer that is collecting data.

2. The apparatus according to claim 1, wherein the collaboration analyzer is executed by the at least one hardware processor to determine, based on the correlated ESG dimensions for each ESG data analyzer of the plurality of ESG data analyzers, the collaboration potential between the plurality of ESG data analyzers by:
determining, for each pair of ESG data analyzers of the plurality of ESG data analyzers, a degree to which ESG data analyzers of the pair of ESG data analyzers collaborate with each other to enrich their data collection.

3. The apparatus according to claim 1, wherein the collaboration potential analyzer is executed by the at least one hardware processor to generate, based on the collaboration potential between the plurality of ESG data analyzers, the decentralized groups of collaborating ESG data analyzers by:
generating a collaboration graph between the plurality of ESG data analyzers,
wherein, for the collaboration graph, weights of edges represent collaboration potentials between connected ESG data analyzers.

4. The apparatus according to claim 3, wherein the collaboration potential analyzer is executed by the at least one hardware processor to generate the collaboration graph between the plurality of ESG data analyzers by:
retaining, for the collaboration graph, edges that include a collaboration potential that is greater than a specified threshold.

5. The apparatus according to claim 1, wherein the anomalous event analyzer is executed by the at least one hardware processor to identify, for the ESG data analyzer that is collecting data and based on the associated updated data model, the potential anomalous ESG event at the specific ESG dimension by:
rebuilding, for the ESG data analyzer that is collecting data, a local data model to generate the updated data model; and
determining a difference between the updated data model from the local data model.

6. The apparatus according to claim 1, wherein the anomalous event analyzer is executed by the at least one hardware processor to:
determine, for a specified number of ESG dimensions, whether a data anomaly is true for the OAE associated with the ESG data analyzer; and
identify, based on a determination that the data anomaly is true for the OAE associated with the ESG data analyzer for the specified number of ESG dimensions, the potential anomalous ESG event.

7. The apparatus according to claim 1, wherein the anomalous event analyzer is executed by the at least one hardware processor to:
determine, for a specified number of OAEs in a cluster of OAEs, whether a data anomaly is true; and
identify, based on a determination that the data anomaly is true for the specified number of OAEs in the cluster of OAEs, the potential anomalous ESG event for the cluster of OAEs.

8. The apparatus according to claim 1, wherein the anomalous event analyzer is executed by the at least one hardware processor to:
determine, for a specified number of OAEs in a cluster of OAEs, whether a data anomaly is true for a specified ESG dimension; and
identify, based on a determination that the data anomaly is true for the specified ESG dimension for the specified number of OAEs in the cluster of OAEs, the potential anomalous ESG event at a global level for the specified ESG dimension.

9. A method for energy efficient collaboration for environmental social and governance (ESG) data consolidation and validation, the method comprising:
identifying, by at least one hardware processor, based on a global correlation graph, correlated ESG dimensions for each ESG data analyzer of a plurality of ESG data analyzers with respect to a set of ESG dimensions on which an ESG data analyzer of the plurality of ESG data analyzers collects data for at least one organization avatar entity (OAE) of a plurality of OAEs;
generating, by the at least one hardware processor, based on a collaboration potential between the plurality of ESG data analyzers, decentralized groups of collaborating ESG data analyzers;
updating, by the at least one hardware processor, for each decentralized group of the decentralized groups of collaborating ESG data analyzers, a data model for each ESG data analyzer with respect to each ESG dimension corresponding to each OAE for which the ESG data analyzer is collecting data;
identifying, by the at least one hardware processor, for the ESG data analyzer that is collecting data and based on an associated updated data model, a potential anomalous ESG event at a specific ESG dimension; and
controlling, by the at least one hardware processor, based on the identified potential anomalous ESG event, operation of the OAE associated with the ESG data analyzer that is collecting data.

10. The method according to claim 9, further comprising:
determining, by the at least one hardware processor, local correlations between ESG dimensions by determining correlation between historical data sets for corresponding ESG dimensions;
generating, by the at least one hardware processor, based on the determined local correlations and for each OAE of a plurality of OAEs, a local correlation graph of associated ESG dimensions;
determining, by the at least one hardware processor, based on the local correlation graph of associated ESG dimensions, global correlations between the ESG dimensions by determining mean correlation between specified ESG dimensions across the plurality of OAEs; and
generating, by the at least one hardware processor, based on the determined global correlations and for each OAE of the plurality of OAEs, the global correlation graph of associated ESG dimensions.

11. The method according to claim 9, further comprising:
determining, by the at least one hardware processor, based on the correlated ESG dimensions for each ESG data analyzer of the plurality of ESG data analyzers, the collaboration potential between the plurality of ESG data analyzers.

12. The method according to claim 9, wherein generating, by the at least one hardware processor, based on the collaboration potential between the plurality of ESG data analyzers, the decentralized groups of collaborating ESG data analyzers further comprises:
generating, by the at least one hardware processor, a collaboration graph between the plurality of ESG data analyzers,
wherein, for the collaboration graph, weights of edges represent collaboration potentials between connected ESG data analyzers.

13. The method according to claim 12, wherein generating, by the at least one hardware processor, the collaboration graph between the plurality of ESG data analyzers further comprises:
retaining, for the collaboration graph, edges that include a collaboration potential that is greater than a specified threshold.

14. A non-transitory computer readable medium having stored thereon machine readable instructions, the machine readable instructions, when executed by at least one hardware processor, cause the at least one hardware processor to:
identify, for an environmental social and governance (ESG) data analyzer that is collecting data and based on an associated updated data model, a potential anomalous ESG event at a specific ESG dimension; and
control, based on the identified potential anomalous ESG event, operation of an organization avatar entity (OAE) associated with the ESG data analyzer that is collecting data.

15. The non-transitory computer readable medium according to claim 14, wherein the machine readable instructions, when executed by the at least one hardware processor, further cause the at least one hardware processor to:
identify, based on a global correlation graph, correlated ESG dimensions for each ESG data analyzer of a plurality of ESG data analyzers with respect to a set of ESG dimensions on which the ESG data analyzer of the plurality of ESG data analyzers collects data for at least one OAE of a plurality of OAEs.

16. The non-transitory computer readable medium according to claim 15, wherein the machine readable instructions, when executed by the at least one hardware processor, further cause the at least one hardware processor to:
generate, based on a collaboration potential between the plurality of ESG data analyzers, decentralized groups of collaborating ESG data analyzers.

17. The non-transitory computer readable medium according to claim 16, wherein the machine readable instructions, when executed by the at least one hardware processor, further cause the at least one hardware processor to:
update, for each decentralized group of the decentralized groups of collaborating ESG data analyzers, a data model for each ESG data analyzer with respect to each ESG dimension corresponding to each OAE for which the ESG data analyzer is collecting data.

18. The non-transitory computer readable medium according to claim 14, wherein the machine readable instructions to identify, for the ESG data analyzer that is collecting data and based on the associated updated data model, the potential anomalous ESG event at the specific ESG dimension, when executed by the at least one hardware processor, further cause the at least one hardware processor to:
rebuild, for the ESG data analyzer that is collecting data, a local data model to generate the updated data model; and
determine a difference between the updated data model from the local data model.

19. The non-transitory computer readable medium according to claim 14, wherein the machine readable instructions, when executed by the at least one hardware processor, further cause the at least one hardware processor to:
determine, for a specified number of ESG dimensions, whether a data anomaly is true for the OAE associated with the ESG data analyzer; and
identify, based on a determination that the data anomaly is true for the OAE associated with the ESG data analyzer for the specified number of ESG dimensions, the potential anomalous ESG event.

20. The non-transitory computer readable medium according to claim 14, wherein the machine readable instructions, when executed by the at least one hardware processor, further cause the at least one hardware processor to:
determine, for a specified number of OAEs in a cluster of OAEs, whether a data anomaly is true for the specific ESG dimension; and
identify, based on a determination that the data anomaly is true for the specific ESG dimension for the specified number of OAEs in the cluster of OAEs, the potential anomalous ESG event at a global level for the specific ESG dimension.
